(19) United States
(12) Patent Application Publication
(10) Pub. No.: US 2013/0104076 A1
(43) Pub. Date: Apr. 25, 2013

(54) ZOOMING-IN A DISPLAYED IMAGE

(71) Applicants: Sorin Alexandru Cristescu, Eindhoven (NL); Tibor Duliskovich, Brookfield, WI (US); Jacobus Sigbertus Marie Geraats, Eindhoven (NL); Harold Johannes Antonius Peeters, Leende (NL); Wijnand Post, 's-Hertogenbosch (NL)

(72) Inventors: Sorin Alexandru Cristescu, Eindhoven (NL); Tibor Duliskovich, Brookfield, WI (US); Jacobus Sigbertus Marie Geraats, Eindhoven (NL); Harold Johannes Antonius Peeters, Leende (NL); Wijnand Post, 's-Hertogenbosch (NL)

(73) Assignee: KONINKLIJKE PHILIPS ELECTRONICS N.V., EINDHOVEN (NL)

(21) Appl. No.: 13/805,068

(22) PCT Filed: Jun. 29, 2011
(86) PCT No.: PCT/IB11/52857

§ 371 Date: Dec. 18, 2012

Related U.S. Application Data
(60) Provisional application No. 61/359,870, filed on Jun. 30, 2010.

(51) Int. Cl. G06F 3/0485

(52) U.S. Cl. CPC G06F 3/0485
USPC 715/800

(57) ABSTRACT

A system for displaying an image is disclosed. A user input subsystem (1) is arranged for enabling a user to indicate at least one point of a region of interest of an image (5). A zoom subsystem (2) is arranged for performing a zoom-in operation by filling a viewport with successively smaller portions of the image (5), wherein the successively smaller portions are selected such that the region of interest is shown at a decreasing distance from a center of the viewport. The user input subsystem (1) is arranged for enabling the user to control the zoom-in operation by indicating, after the viewport has been filled with one or more of the successively smaller portions of the image, whether further zooming is desired for the, already indicated, at least one point of a region of interest.

### FIELD OF THE INVENTION

The invention relates to displaying an image. The invention further relates to zooming-in a displayed image.

### BACKGROUND OF THE INVENTION

Magnifying parts of diagnostic images is important for medical image interpretation, as it allows a better view of anatomical structures relevant for diagnostic purposes. In the case of conventional X-ray film, this was achieved by means of a magnifying glass which was held and moved around in front of the film on a light-box. In the digital age, many image viewing applications offer pan and zoom functionality to enable a user to select a portion of an image for viewing at a selected magnification or zoom level. Medical imaging applications may offer pan and zoom functionality to enable a user to analyze the images and any pathologies visible in the images in greater detail. The zoom functionality is also used for other kinds of images, such as geographic maps in navigation systems. Typical imaging applications use zoom and pan functionality in order to allow a user to expose places of interest in the image and to show details of those places. Zoom (enlargement) and pan (translation) are considered basic operations to imaging applications, and therefore they are frequently used during an imaging interpretation session.

In existing image viewing applications, the zoom operations are typically oriented to the center of the viewport: during zoom-in and zoom-out operations, the center of the viewport is kept stationary. In other words, the image point which is displayed at the center of the viewport remains at the center, while the remaining image points diverge away from the center or converge towards the center. Alternatively, a point in the image is selected using a mouse pointer, and this point is kept fixed during the zoom operation. The remaining points diverge away from this point or converge towards this point. This means that an indicated pixel remains fixed, while the other image pixels move away from (for zoom-in) or towards (for zoom out) that pixel.

However, users may have difficulty to obtain a good view of a particular region of interest of the image. Also, relatively complex user interaction may be necessary in order to generate a view of a desired region of interest, such as a particular organ or pathology. Consequently, the result of the pan/zoom operations performed by the user may be erratic and/or confusing for the user.

### SUMMARY OF THE INVENTION

It would be advantageous to have an improved system for displaying an image. To better address this concern, a first aspect of the invention provides a system comprising:

a user input subsystem for enabling a user to indicate at least one point of a region of interest of an image;

a zoom subsystem for performing a zoom-in operation by filling a viewport with successively smaller portions of the image, wherein the successively smaller portions are selected such that the region of interest is shown at a gradually decreasing distance from a center of the viewport.

By successively, gradually decreasing the distance between the region of interest and the center of the viewport, the region of interest is in effect moved towards the center of the viewport. The system is arranged to determine the grade, i.e. the speed, of gradually decreasing the distance between the region of interest and the center of the viewport in such a way that it is avoided that the region of interest partially or completely moves out of the viewport due to the zoom-in operation. This grade may depend on the size and location of the region of interest and a measure of the distance between the region and the border of the viewport. When the center of the viewport is fixed during zoom-in, the points around the center of the viewport diverge, such that a region of interest which is not at the center of the viewport will eventually move out of view. When the selected point is kept fixed, and the selected point is not located at the center of the viewport, a part of the region of interest will move out of view before the region of interest is shown at maximum magnification, wherein the maximum magnification is the magnification at which the region of interest can be shown completely inside the viewport. This maximum magnification can be achieved when the region of interest is shown around the center of the viewport, or more particularly, when the center of the region of interest coincides with the center of the viewport. Consequently, by moving the region of interest towards the center of the viewport, a relatively large portion of the region of interest, or the complete region of interest, may be shown during and after the zoom-in operation.

The user input subsystem may be arranged for enabling the user to control the zoom-in operation by indicating, after the viewport has been filled with one or more of the successively smaller portions of the image, whether further zooming is desired for the, already indicated, at least one point of a region of interest. This makes the zoom-in operation more interactive. For example, the user input subsystem may be arranged for enabling the user to control the zoom-in operation in real-time. The gradually decreasing distance of the region of interest to the center of the viewport is useful in such an interactive zoom-in operation. For example, both the speed and duration of the zoom-in operation may be controlled by the speed and duration of a mouse drag operation performed by the user. The zoom-in may be similarly controlled by rotating the mouse wheel, or by moving one or more fingers on a touch screen. Alternatively, the display of successively smaller portions may continue as long as a particular button is kept depressed. Consequently, it is not necessary to indicate beforehand the amount of zoom-in desired.

The user input subsystem may be arranged for enabling the user to control a speed of zooming in. Moreover, the zoom subsystem may be arranged for controlling a speed of decreasing the distance in dependence on the speed of zooming in. This allows for a natural zoom effect. Herein, the speed of zooming-in may refer to a speed at which the scale factor is increased during the zoom-in operation. The user may be enabled to control said speed of zooming-in in real-time during the zoom-in operation, adjusting the speed of zooming-in while the zoom-in operation takes place. For example, the zoom-in speed may be made dependent on the speed at which the user drags a mouse device. The system may be arranged such that the speed at which the distance from the region of interest to the center of the viewport decreases is dependent on the zoom-in speed. For example, in an embodiment of the system, the speed at which the distance from the region of interest to the center of the viewport decreases, may be proportional to the zoom-in speed. This makes the appearance of the zoom-in operation more natural.

The user input subsystem may be arranged for obtaining an indicated point from the user in the process of indicating at least one point of the region of interest of the image. Moreover, the successively smaller portions, when filling the viewport, may have the indicated point at a decreasing distance from the center of the viewport. By using the indicated point as the reference point of the distance, the system does not need to explicitly determine the region of interest. Indeed, moving the indicated point towards the center of the viewport also causes a region of interest around that point to be moved towards the center of the viewport. Moreover, the user will get used to indicating the center of a desired region of interest as the indicated point.

The system may comprise a region detector for detecting the region of interest, based on the at least one point and a content of the image. This makes it easier to indicate the region of interest, because it does not matter which point in the region of interest the user indicates. The region detector may comprise an object detector configured to detect an object at the indicated position; the region of interest may correspond to the detected object. The zoom subsystem may be configured to move a center of the region of interest towards the center of the viewport. This allows zooming-in on the region of interest with relatively little effort.

The zoom subsystem may be arranged for keeping an image point fixed at a fixed point of the viewport, wherein the fixed point is located on a line intersecting the center of the viewport and the region of interest of the image, wherein the region of interest is in between the center of the viewport and the fixed point. This way, the region of interest remains within the viewport. Because of the zoom-in operations, the points around the fixed point diverge away from the fixed point. Because of the location of the fixed point, the region of interest will move towards the center of the viewport.

More particularly, the line may intersect the point indicated by the user. This way, the user can control more precisely which part of the image will move towards the center of the viewport.

The fixed point may be located on an intersection of the line and an outer boundary of the viewport. This way, regardless of the size of the region of interest, the region of interest does not move outside the available viewport.

The zoom subsystem may be arranged for relocating the fixed point to the center of the viewport when the region of interest is at the center of the viewport. This way, when the region of interest is at the center of the viewport, it is kept there. This enables enlarging the region of interest as much as possible.

The zoom subsystem may be arranged for relocating the fixed point to the center of the viewport when the point indicated by the user is at the center of the viewport. This gives the user more control over which point of the region of interest will be kept at the center of the viewport.

The zoom subsystem may be arranged for decreasing the distance with a decreasing step size, which step size reaches zero when the region of interest or the selected point reaches the center of the viewport. In other words, the moving of the region of interest towards the center of the viewport is performed at a decreasing, or decelerating, pace, which pace reaches zero when the region of interest or the selected point of the region of interest reaches the center of the viewport. This makes the zoom-in operation smoother. Moreover, by moving the region of interest towards the center at a relatively high pace as long as the region of interest is relatively far away from the center of the viewport (and thus relatively close to the boundary of the viewport), it may be avoided that any portion of the region of interest or any structure close to the region of interest disappears from the viewport. The pace may be decreased smoothly for a pleasing zoom-in experience.

In another aspect, the invention provides a workstation comprising the system set forth.

In another aspect, the invention provides an image acquisition apparatus comprising the system set forth.

In yet another aspect, the invention provides a method of displaying an image, comprising:

enabling a user to indicate at least one point of a region of interest of an image;

performing a zoom-in operation by filling a viewport with successively smaller portions of the image, wherein the successively smaller portions are selected such that the region of interest is shown at a decreasing distance from a center of the viewport.

In another aspect, the invention provides a computer program product comprising instructions for causing a processor system to perform the method set forth.

It will be appreciated by those skilled in the art that two or more of the above-mentioned embodiments, implementations, and/or aspects of the invention may be combined in any way deemed useful.

Modifications and variations of the image acquisition apparatus, the workstation, the method, and/or the computer program product, which correspond to the described modifications and variations of the system, can be carried out by a person skilled in the art on the basis of the present description.

A person skilled in the art will appreciate that the system may be applied to multi-dimensional image data, e.g. to two-dimensional (2-D), three-dimensional (3-D) or four-dimensional (4-D) images, acquired by various acquisition modalities such as, but not limited to, standard X-ray Imaging, Computed Tomography (CT), Magnetic Resonance Imaging (MRI), Ultrasound (US), Positron Emission Tomography (PET), Single Photon Emission Computed Tomography (SPECT), and Nuclear Medicine (NM).

### BRIEF DESCRIPTION OF THE DRAWINGS

These and other aspects of the invention are apparent from and will be elucidated with reference to the embodiments described hereinafter. In the drawings,

FIG. 1 is a block diagram of a system for displaying an image;

FIG. 2 is a flow chart of a method of displaying an image;

FIG. 3 is a diagram of a display comprising a viewport;

FIG. 4A is a diagram of an image and a portion thereof;

FIG. 4B is a diagram of an image and a further portion thereof.

### DETAILED DESCRIPTION OF EMBODIMENTS

In digital imaging, an image may be displayed at many different scales. Such scales may also be referred to as magnification factors or zoom levels. The term “zoom” may refer to enlarging a portion of an image on the screen, for example based on pixel interpolation of the image data. Also, when considering three-dimensional images, it may be noted that a two-dimensional representation, for example a projection, may be visualized in a viewport of a display. Such a two-dimensional representation is again an image which may be zoomed in and out. Panning of an image may refer to a translation of the image with respect to the viewport, i.e. after panning another portion of the image is displayed in the viewport, in principle at the same zoom level.

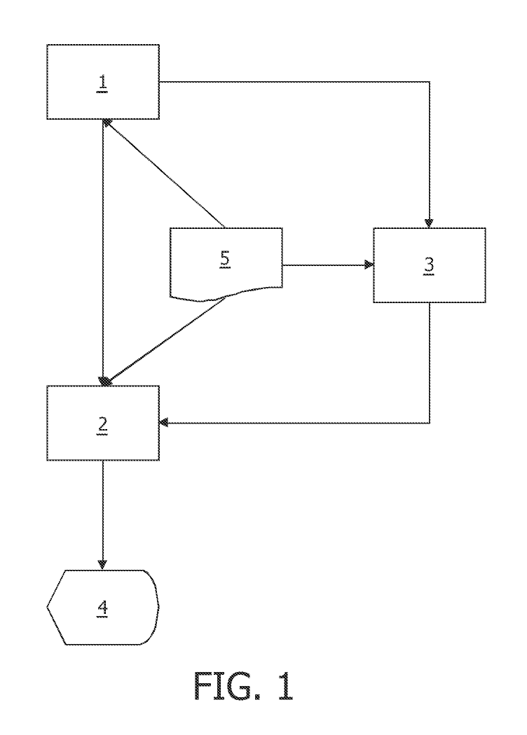

FIG. 1 illustrates a system for displaying an image. The system may comprise a display for displaying an image, a user input device such as a mouse and/or a keyboard for enabling a user to control the system, and a communications port for connecting the system to a source of images, such as a picture archiving and communication system. Moreover, the system may comprise local storage means for storing one or more images and/or a computer program to be executed by a processor. These possible elements of the system are not shown in the drawing.

The system may comprise a user input subsystem 1 for enabling a user to indicate at least one point of a region of interest of an image 5. For example, the user input subsystem 1 is coupled to a mouse pointing device to receive coordinates of a mouse pointer when a user clicks on a button of the mouse pointing device while the mouse pointer is at a point of a viewport.

The system may further comprise a zoom subsystem 2 for performing a zoom-in operation by filling a viewport with successively smaller portions of the image 5. The zoom subsystem 2 may further be arranged for performing a zoom-out operation by filling the viewport with successively larger portions of the image 5. When the viewport is filled with a smaller portion of the image, the image is shown at a greater magnification, because the viewport size is not affected by the zoom operation. However, a separate functionality may be provided to enable a user to resize the viewport. The zoom-in operations and zoom-out operations may be controlled by a user, via the user input subsystem 1. Moreover, the zoom subsystem may comprise a pan subsystem enabling a user to pan the image, i.e. by shifting the image upwards, downwards, leftwards, or rightwards.

When zooming in, the zoom subsystem may be configured to select the successively smaller portions such that the region of interest is shown at a decreasing distance from a center of the viewport. For example, a vector may be computed pointing from a point of the region of interest towards the center of the viewport. That point of the region of interest may be shifted in the direction indicated by the vector, while increasing the scale at which the image is displayed.

The user input subsystem 1 may be arranged for enabling the user to control the zoom-in operation by indicating, after the viewport has been filled with one or more of the successively smaller portions of the image, whether further zooming is desired for the, already indicated, at least one point of a region of interest. The zoom operation may be controlled in real-time, allowing the user to control the scale of the image by means of user commands, which user commands may be indicative of an increase or a decrease of the scale factor at which the image is to be displayed. In response to receipt of a command indicative of an increase of the scale factor (i.e., an increase of the zoom level), the zoom subsystem fills the viewport with a smaller portion of the image 5, and consequently shows the region of interest at a smaller distance to the center of the viewport. Alternatively, the successive portions of the image are shown at predefined time intervals, and the user commands are used to start/stop the zoom process and/or to control the speed of the zoom operation. The speed at which the region of interest and/or the indicated point is moved towards the center of the viewport may be made dependent, for example proportionally dependent, on the speed of the zoom operation.

In general, there are at least two possibilities for the zoom-in operation. First, a region of interest may be determined, and the distance to the center of the viewport is computed with respect to a reference point within the region of interest. This reference point may be the center of the region of interest or the point of the region of interest which is closest to the center of the viewport. Second, a point of the region of interest is indicated by the user, and the distance to the center of the viewport is computed with respect to this point. In the second alternative, the extent of the region of interest is not considered. Consequently, the user input subsystem 1 may be arranged for obtaining an indicated point from the user in the process of indicating the at least one point of the region of interest of the image. During the zoom-in operation, the successively smaller portions, when filling the viewport, have the indicated point at a decreasing distance from the center of the viewport.

The system may comprise a region detector 3 for detecting the region of interest, based on the information provided by the user (usually at least one point) and a content of the image 5. For example, edge detection may be performed around the indicated point, and the region of interest may be defined as the region around the indicated point bounded by the first edge found.

FIG. 3 illustrates a display area 301 of a display device. The display device can be, for example, a computer monitor, a television, or a mobile device such as a mobile phone or a pda. The display area 301 may show information from one or more applications, for example using a window system. However, the use of a window system is not a limitation.

The display area 301 may comprise a viewport 302. Generally, a viewport should be understood to correspond to at least a portion of the display area 301. The viewport may be a sub-area of the display area 301, and suitable for display of at least a portion of an image. The viewport may also correspond to the complete display area 301. The concept of viewport should not be limited to any particular kind of widget of a windowing system, as a viewport can be implemented in many ways known to the skilled person. The Figure also indicates the center 303 of the viewport 302.

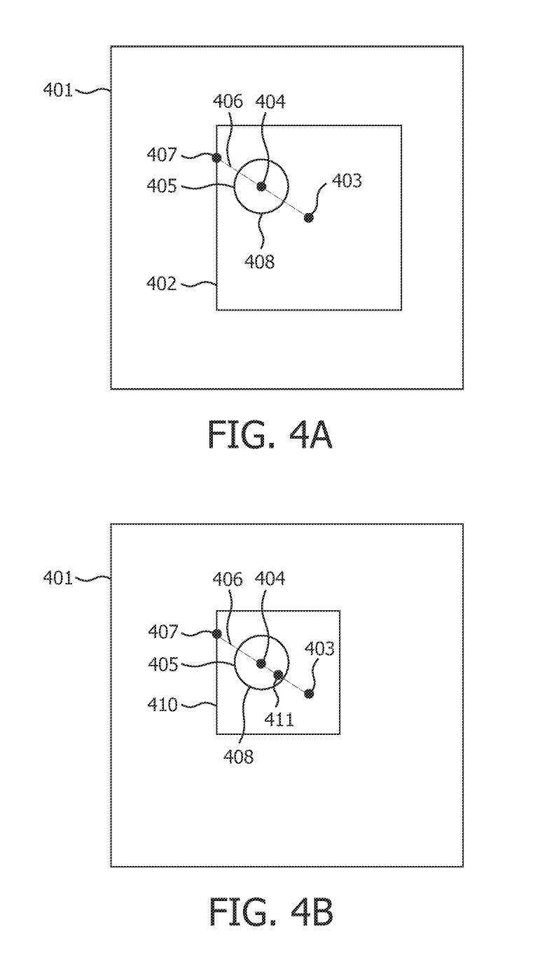

FIG. 4A illustrates an image 401. The image represents pictorial information of an image area shown as the box at numeral 401. Typically, the image 401 contains information about values of pixels of the image area. These pixels are not shown in the Figure. The Figure does show a portion 402 of the image 401. The portion 402 can be displayed in the viewport 302 of the display area 301. Typically the center 403 of the portion 402 is displayed at the center 303 of the viewport 302. The remainder of the portion 402 is scaled such that it fills the viewport 302.

FIG. 4B illustrates the same image 401. Throughout the Figures, similar items are labeled with the same reference numerals. It shows another portion 410 of the image 401, with center 411. The center 403 of the portion 402 of FIG. 4A is also indicated in FIG. 4B.

The distance from the center 303 of the viewport 302 at which the region of interest 408 is shown may be expressed in a viewport coordinate system. Since the smaller portion 410 fills the same viewport 302 area as the original portion 402, the scale at which the image portions are shown is different. Using a viewport coordinate system to compute the distance allows correcting for this scale difference.

In the following, aspects of the system shown in FIG. 1 will be explained with reference to FIGS. 3, 4A, and 4B.

In FIG. 4A, a line 406 has been drawn intersecting the center 403 of the portion 402 of the image area 401, corresponding to the center 303 of the viewport 302. The same line is shown in FIG. 4B, and it can be seen that in this example, the center 411 of the portion 410 of the image area 401 also lies on the line 406. This may be achieved by arranging the zoom subsystem 2 so as to keep an image point fixed at a fixed point of the viewport, wherein the fixed point is located on the line 406 intersecting the center 303, 403 of the viewport 302 and the region of interest 408 of the image, wherein the region of interest 408 is in between the center 303, 403 of the viewport and the fixed point. As mentioned before, when the viewport 302 is filled with the portion 402, the center 403 of the portion 402 corresponds to the center 303 of the viewport 302. The line 406 may be selected such that the line 406 intersects the point 404 indicated by the user.

As illustrated in FIG. 4A, the fixed point 407 may be located on an intersection of the line 406 and an outer boundary of the viewport 302, which corresponds to an outer boundary of the portion 402. FIG. 4B shows the resulting smaller portion 410 of the image area 401 which may displayed in the viewport 302 when the point 407 is kept fixed in the viewport. It is shown in the Figure, that the center 411 of the smaller portion 410 is on the same line 406, and it is also shown that the region of interest 408 is completely contained within the smaller portion 410. The selection of the point 407 on the line 406, with the region of interest 408 in between the center 403 and the point 407, makes sure that the region of interest 408 remains within the smaller portion 410. This is achieved by choosing the point 407 on the outer boundary of the viewport 302 or portion 410, without considering the extent of the region of interest, as long as the region of interest is within the original portion 402 of the image area 401.

The zoom subsystem 2 may be arranged for relocating the fixed point 407 to the center 303 of the viewport when the region of interest 408 is at the center of the viewport.

Here, “at the center” may be understood as “centered around the center of the viewport”. However, this is not a limitation. This way, when the region of interest 408 has reached the center of the viewport, any further zoom-in keeps the region of interest at the center.

More particularly, the zoom subsystem 2 may be arranged for relocating the fixed point 407 to the center of the viewport when the point indicated by the user is at the center of the viewport.

The zoom subsystem 2 may be arranged for reducing the distance from the region of interest 408 or point 404 to the center 403, 411, 303 with a decreasing step size, which step size reaches zero when the region of interest 408 or the point 404 indicated by the user reaches the center 303 of the viewport 302. This way, a smoothly decelerating panning of the image may be obtained. The decreasing step size may be obtained by moving the fixed point 407 along the line 406 in the direction of the viewport center 303, which coincides with center 403.

The system can be implemented as a suitably programmed computer workstation. The system can also be incorporated in an image viewing portion of an image acquisition apparatus. Such an image acquisition apparatus can be a computed tomography scanner, an x-ray scanner, an ultrasound scanner, a photographic camera, or any other image scanner. The system can also at least partly be implemented as a web service, wherein the zoom functionality is provided by a web application. The system can also be incorporated in a mobile device such as a mobile phone or pda.

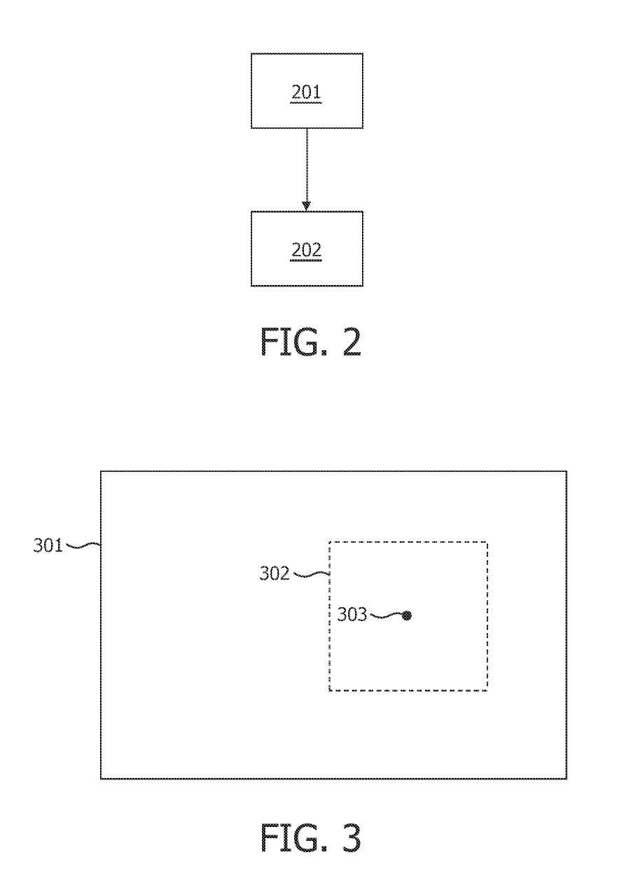

FIG. 2 illustrates a method of displaying an image. The method comprises step 201 of enabling a user to indicate at least one point of a region of interest of an image. Moreover, the method comprises step 202 of performing a zoom-in operation by filling a viewport with successively smaller portions of the image, wherein the successively smaller portions are selected such that the region of interest is shown at a decreasing distance from a center of the viewport. The step 202 may be controlled by a user in real-time in respect of speed and/or duration of the zoom-in operation. Herein, speed of the zoom-in operation may be understood as an increase in scale factor per second. Control of duration may be understood as the possibility to stop the zoom-in operation at any time, leaving the image visualization in the viewport as it is at that time. This method, and other methods based on the functionalities described in this document, may be implemented by means of a computer program product comprising instructions for causing a processor system to perform the method.

The zoom subsystem may be configured to zoom in around the point on the viewport edge that guarantees that the region of interest moves towards the viewport center, and/or zoom out around a unique fixed point, i.e. the point in the image that guarantees that, when zooming out, the image will come gradually towards its original position until it fits the viewport completely, without any perceived changes in the direction in which the image is moved.

Once the image fits the viewport, zoom-out must not be allowed any longer, since that would bring more non-image information inside the viewport. In other words, the viewport area would be used less efficiently, because the same image information could be displayed at a larger scale.

Also, panning may be restricted such that it is made inpossible for the outer boundary of the image to cross the viewport. This way, the image cannot be panned ‘out of view’. In particular, panning may be restricted such that it is not allowed to bring more non-image information inside the viewport than that already present. Herein, non-image information refers to a portion of the viewport which is unused because the image does not contain information for that portion of the viewport in view of the current pan/zoom settings. When the aspect ratios of the image and the viewport are the same, the system can be made such that the viewport is always completely filled with image information by refusing panning or zoom-out when it would introduce non-image information inside the viewport. However, this is not a limitation.

The “fixed point” described in this description refers to a point of the image which is kept fixed at a particular point of the viewport during a zoom-in or a zoom-out operation. It will be appreciated that a subsequent zoom-in or zoom-out operation may use a different fixed point, in particular if the image has been panned in between zoom operations or if the user indicates a different point or region of interest.

The following constraints are considered to provide user-friendly zoom and pan functionality for an image viewer. However, these constraints are not limitations.

a. Do not allow panning of the image beyond the outside boundary of the image, i.e. if it would cause a portion of the viewport to be unused. If a portion of the viewport is already unused, do not allow panning which would increase the unused portion of the viewport.

b. For zoom out: when the image is displayed completely within the viewport, further zoom-out is disabled. This again avoids that a portion of the viewport becomes needlessly unused. Of course, when the aspect ratio of the image and the viewport are not the same, a portion of the viewport will be unused when the image is displayed completely within the viewport; however this is not regarded as a disadvantage.

c. For zoom out: avoid changes in the direction in which pixels are moved during zooming (i.e. avoid a zig-zag effect), while ensuring that as much image information as possible is displayed for any given scale factor. This may be achieved by gradually zooming the image towards a scale factor at which the image just fits within the viewport, while keeping a fixed point fixed within the viewport, wherein the fixed point depends on a panning parameter and a zoom parameter of the image at the time zooming starts, wherein the fixed point is a point of the image which is being displayed in the viewport at the time zooming starts, and wherein the image is capable of being zoomed to a zoom level at which the image just fits within the viewport, while the fixed point is kept fixed.

d. For zoom-in: Keep a (e.g. user-defined) region of interest inside the viewport when zooming in. For example, the region centered around a user-indicated position such as the initial mouse pointer location before a zoom-in operation starts may be kept inside the viewport by directing the zoom-in appropriately. For example, the region of interest or indicated position may be moved towards the center of the viewport while zooming in.

It will be appreciated that the invention also applies to computer programs, particularly computer programs on or in a carrier, adapted to put the invention into practice.

The program may be in the form of a source code, an object code, a code intermediate source and object code such as in a partially compiled form, or in any other form suitable for use in the implementation of the method according to the invention. It will also be appreciated that such a program may have many different architectural designs. For example, a program code implementing the functionality of the method or system according to the invention may be sub-divided into one or more sub-routines. Many different ways of distributing the functionality among these sub-routines will be apparent to the skilled person. The sub-routines may be stored together in one executable file to form a self-contained program. Such an executable file may comprise computer-executable instructions, for example, processor instructions and/or interpreter instructions (e.g. Java interpreter instructions). Alternatively, one or more or all of the sub-routines may be stored in at least one external library file and linked with a main program either statically or dynamically, e.g. at run-time. The main program contains at least one call to at least one of the sub-routines. The sub-routines may also comprise function calls to each other. An embodiment relating to a computer program product comprises computer-executable instructions corresponding to each processing step of at least one of the methods set forth herein. These instructions may be sub-divided into sub-routines and/or stored in one or more files that may be linked statically or dynamically. Another embodiment relating to a computer program product comprises computer-executable instructions corresponding to each means of at least one of the systems and/or products set forth herein. These instructions may be sub-divided into sub-routines and/or stored in one or more files that may be linked statically or dynamically.

The carrier of a computer program may be any entity or device capable of carrying the program. For example, the carrier may include a storage medium, such as a ROM, for example, a CD ROM or a semiconductor ROM, or a magnetic recording medium, for example, a floppy disc or a hard disk. Furthermore, the carrier may be a transmissible carrier such as an electric or optical signal, which may be conveyed via electric or optical cable or by radio or other means. When the program is embodied in such a signal, the carrier may be constituted by such a cable or other device or means. Alternatively, the carrier may be an integrated circuit in which the program is embedded, the integrated circuit being adapted to perform, or used in the performance of, the relevant method.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A system for displaying an image, comprising:
a user input subsystem for enabling a user to indicate an least one point of a region of interest of an image;
a zoom subsystem for performing a zoom-in operation by filling a viewport with successively smaller portions of the image, wherein the successively smaller portions are selected such that the region of interest is shown at a gradually decreasing distance from a center of the viewport;
wherein the zoom subsystem is arranged for reducing the distance with a decreasing step size, which step size reaches zero when the region of interest indicated by the user reaches the center of the viewport.

2. The system according to claim 1, wherein the user input subsystem is arranged for enabling the user to control the zoom-in operation by indicating, after the viewport has been filled with one or more of the successively smaller portions of the image, whether further zooming is desired for the, already indicated, at least one point of a region of interest.

3. The system according to claim 1, wherein the user input subsystem is arranged for enabling the user to control a speed of zooming in, and wherein the zoom subsystem is arranged for controlling a speed of decreasing the distance in dependence on the speed of zooming in.

4. The system according to claim 1, wherein the user input subsystem is arranged for obtaining an indicated point, from the user in the process of indicating the at least one point of the region of interest of the image, and wherein the successively smaller portions, when filing the viewport, have the indicated point at a decreasing distance from the center of the viewport.

5. The system according to claim 1, further comprising a region detector for detecting the region of interest, based on the at least one point and a content of the image.

6. The system according to claim 1, wherein the zoom subsystem is arranged for keeping an image point fixed at a fixed point of the viewport, wherein the fixed point is located on a line intersecting the center of the viewport and the region of interest of the image, wherein the region of interest is in between the center of the viewport and the fixed point.

7. The system according to claim 5, wherein the line intersects the point indicated by the user.

8. The system according to claim 5, wherein the fixed point is located on an intersection of the line and an outer boundary of the viewport.

9. The system according to claim 5, wherein the zoom subsystem is arranged for relocating the fixed point to the center of the viewport when the region of interest is at the center of the viewport.

10. The system according to claim 8, wherein the zoom subsystem is arranged for relocating the fixed point to the center of the viewport when the point indicated by the user is at the center of the viewport.

11. (canceled)

12. The system according to claim 10, wherein the decreasing step size results in a smoothly decelerating panning of the image.

13. A workstation comprising the system according to claim 1.

14. A method of displaying an image, comprising:
enabling a user to indicate an least one point of a region of interest of an image;
performing a zoom-in operation by filling a viewport with successively smaller portions of the image, wherein the successively smaller portions are selected such that the region of interest is shown at a decreasing distance from a center of the viewport;
wherein the performing the zoom-in operation comprises reducing the distance with a decreasing step size, which step size reaches zero when the region of interest indicated by the user reaches the center of the viewport.

15. A computer program product comprising instructions for causing a processor system to perform the method according to claim. 14.

16. The system according to claim 4, wherein the zoom subsystem is arranged for establishing the step size so as to reach zero when the point indicated by the user reaches the center of the viewport.
